(19) United States
(12) Patent Application Publication
(10) Pub. No.: US 2004/0256181 A1
(43) Pub. Date: Dec. 23, 2004

(54) Compact drive for elevator doors

(76) Inventors: Christophe Durand, Cemoy en Berry (FR); Thierry Bongibault, Ouzouer sur Loire (FR); Michael Morlet, Sully Sur Loire (FR)

Correspondence Address: Otis Elevator Company, 10 Farm Springs Road, Farmington, CT, 06032, US

(21) Appl. No.: 10/490,241

(22) PCT Filed: Sep. 23, 2002
(86) PCT No.: PCT/IB02/03910

(30) Foreign Application Priority Data
Sep. 28, 2001 (FR) 01/12505

(51) Int. Cl. B66B 13/14

(52) U.S. Cl. 187/316

(57) ABSTRACT

The invention concerns a compact drive device, especially for the translation of elevator booth doors, the speed reducer and motor unit used and the support lintel for the doors of the equipped elevator booth. The compact drive device of elevator booth doors, of the type with translation of the doors (1) with the aid of a belt (3) driven in the doors upper support lintel (5) joined to said doors (1), is characterised in that it includes a flat d.c. electric motor (19) associated with a speed reducer placed adjacent to the motor (19), and a drive pulley (7) of relatively large diameter and adapted to cover at least one portion of the width of the reducer so as to reduce the width of the unit constituted by the back-geared motor (19) and the pulley (7), this back-geared motor (19) and pulley (7) unit being fixed to said upper lintel (5) inside the latter.

The invention concerns a compact drive device, especially for the translation of elevator booth doors, the flat electric motor and the attached speed reducer used and a support lintel for the doors of an equipped elevator booth.

The current drive devices for elevator booth doors generally project beyond the roof of the elevator booth and require a relatively large amount of space which can limit the volume of the booth and require that the elevator shaft be higher on account of the top portion of the booth and the residual space required. Moreover, should the system break down, maintenance needs to be effected on the booth roof.

The invention aims to resolve these drawbacks and offers a compact drive device for elevator booth doors and is of the door translation type, said translation being effected using a belt driven in the doors upper support lintel and joined to said doors, said invention being characterised in that it includes a flat d.c. electric motor associated with a speed reducer placed adjacent to the motor, and a drive pulley with a relatively large diameter and adapted to cover at least one portion of the width of the speed reducer so as top reduce the width of the unit constituted by the backgeared motor and the pulley, this backgeared motor and pulley unit being fixed to said upper support lintel inside the latter.

Said speed reducer associated with the flat motor is advantageously of the harmonic, cycloid or epicycloid type and thus having small dimensions so as to be fully housed inside the pulley.

The electric motor is a flat motor with a rotating armature disk fed with low (24 volts) d.c. voltage by a sliding contact collector rubbing on the armature disk.

The disk comprises a low inertia of rotation and allows the reducer significant reduction ratios, up to 1/50 within the permitted movement inertia limit, especially when the doors are suddenly stopped.

Advantageously, the motor and the speed reducer with which the drive pulley is rendered integral are secured to the lintel by a peripheral housing, preferably a support plate, and being placed on both sides of the latter.

The thickness of the motor, the reducer and the pulley is less than or equal to the width of the support lintel, namely 110 mm, so that it does not project outside the lintel.

The motor is conventionally fed by a control block controlling its speed and torque which varies according to the varied voltage and intensity of the current and its torque, especially at the end of travel, on obstacles and in acceleration phase, the voltage being kept to a low value, namely less than or equal to 24 volts, so as to increase electric safety.

The control block and the corresponding 24 volts mains transformer are housed in the lintel without projecting.

The diameter of the pulley, which is relatively large, associated with the torque of the reducer, also large, makes it possible to drive the doors at an adequate speed.

According to this disposition of the invention, it is possible to have a compact drive device housed in the support lintel of the elevator booth doors and forming a homogeneous bloc able to be easily installed without projecting and being accessible for maintenance operations from the stairs-head and which increases the space available in the booth and in the casing outside the latter.

In addition, the back-geared motor disposed as above is relatively quiet when functioning and has low inertia and its movement is reversible.

Moreover, the idle pulley receiving the drive belt of the doors at the other extremity of the lintel in relation to the motor is mounted in a housing or frame fixed on the lintel, this pulley being identical to that of the motor. This disposition reduces the number of required elements.

In addition, a stand-by 24 volts battery can also be installed in the internal section, of the lintel without projecting or slightly projecting.

The invention also concerns an electric and speed reducer motor unit comprising a flat d.c. motor and associated speed reducer placed adjacent and having small dimensions and whose drive pulley covers at least one portion of the width of the reducer, and also a support lintel for the elevator booth doors and equipped with the drive device of the invention.

Preferably, the pulley covers the entire reducer, especially for reducers of said harmonic, cycloid or epicycloid types.

These characteristics and advantages of the invention and others shall be more readily understood from a reading of the following description of an embodiment example of the invention and with reference to the accompanying drawings on which

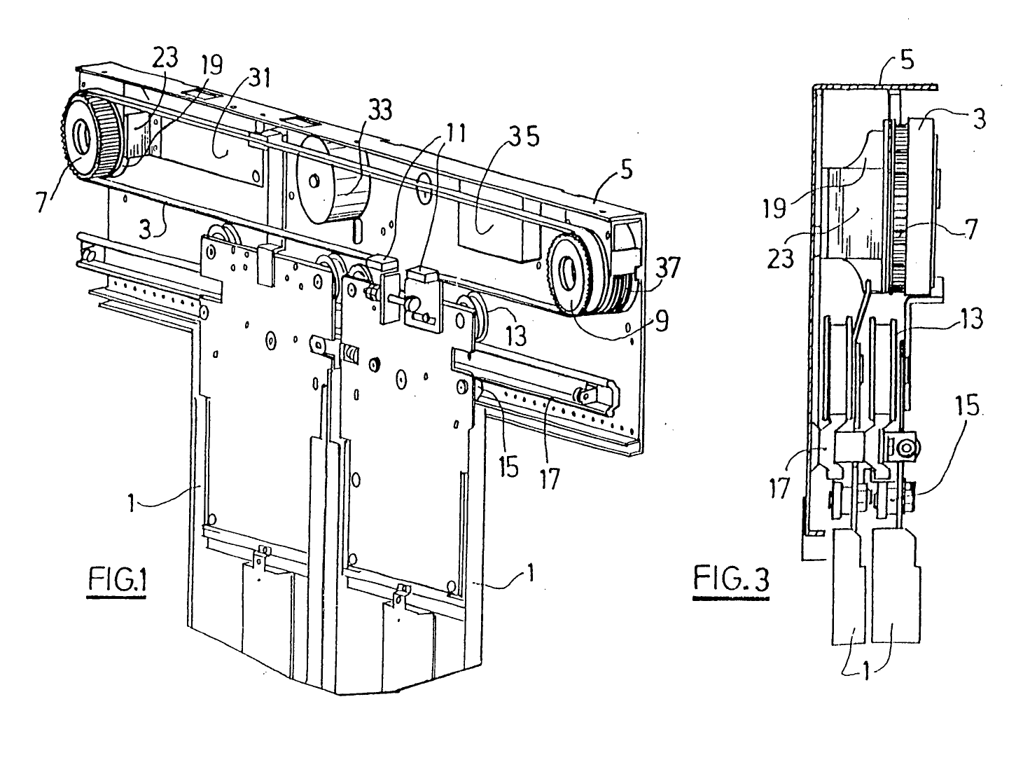

FIG. 1 is a perspective view of a support lintel of the doors of an elevator booth equipped with the drive device of the invention;

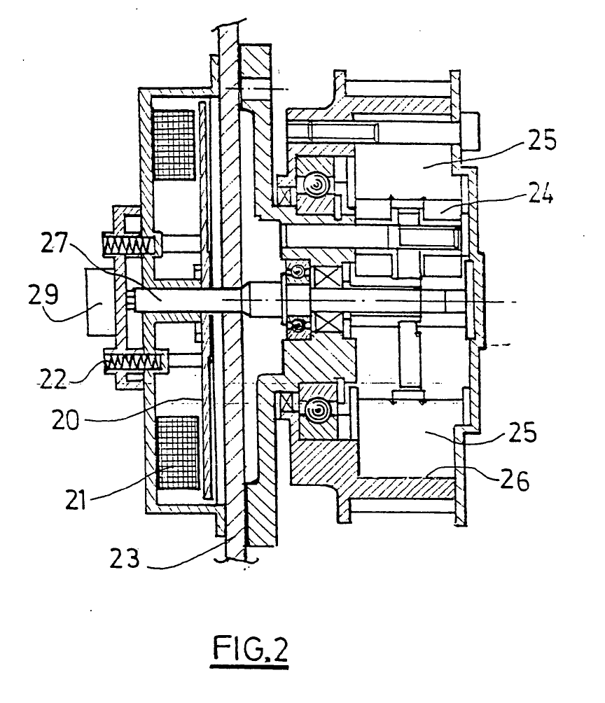

FIG. 2 is a cross section of the unit constituted by the motor and reducer and its drive pulley used in the drive device of the invention, and

FIG. 3 is a cross section of the lintel equipped with the drive device of the invention.

As shown on FIG. 1, the drive device of the invention is represented for an application of the central opening of two elevator booth doors 1. It can equally be applied to other types for booth door opening.

The drive device comprises a notched belt 3 extending along a support lintel 5 of the booth doors 1 at the upper portion of said booth. This belt 3 is driven by a motor pulley 7 at one extremity of the lintel 5 and received at the other extremity by an idle return pulley 9 at the other extremity. The belt 3 is shaped into a longitudinal loop with two nearby extremities 11 fixed by fixing brackets to a given door. The other door is fixed to the other loop end of the belt.

The doors 1 are guided in horizontal translation (FIG. 3) by means of upper support rollers 13 and lower counter-rollers 15 rolling on a rail 17 placed at the lower portion of the lintel 5.

The motor pulley 7 is driven by means of a flat 24 volts low voltage d.c. electric motor 19. As shown on FIG. 2, this motor is a rotating armature disk type small torque motor 20 rotating at a high speed of about 3000 rpm. This disk 20 is fed by a sliding contact collector 22.

In the present case, the stator 21 is constituted by permanent fixed magnets installed coaxially in the form of a ring and laterally in relation to the motor.

The motor 19 and the associated speed reducer 24 are secured coaxially to a given plate 23 suitably folded and fixed to the lintel 5 on both sides of the latter.

The reducer 24 used here is of the epicycloid type, namely comprising a set of rollers 25 driven axially by the motor and rolling moved out of centre gripping inside a cage 26 so as to drive the cage slowly within the speed reduction ratio of the reducer, namely between about 1/40 to 1/20 of the speed of the motor which rotates at about 3000 rmp. In the present case, the cage 26 is formed in the pulley 7 and is an axial smooth internal crown of the pulley.

It is to be noted that this reducer is high-performing and silent. Moreover, the internal crown 26 of the pulley can be advantageously used for the reducer.

The other said reducers of the harmonic or cycloid type function according to a similar moved out of centre principle of the rollers rolling in relation to a slow crown driven and joined axially to the pulley.

Fixed at the opposite extremity of the central shaft 27 of the reducer and motor is a standard Hall effect angle of rotation sensor 29. This Hall effect angle sensor 29 enables control electronics to know the relative position of the rotor so as to control the position and movement command of the door and also to calculate the speed and relative position of the door.

The motor pulley 7, whose outer diameter is approximately that of the motor, covers the reducer 24 which can also be of the harmonic or cycloid type and thus having small dimensions. Thus, the thickness of the reducer, which has a general cylindrical shape, can be reduced down to half that of the pulley 7 and similarly for its diameter, especially as regards the harmonic reducer. Thus, the width of the unit constituted by the motor, the reducer and the motor pulley 7 is small, namely less than or approximately equal to 110 mm which is the depth of the lintel so as to be mounted on the latter without projecting.

The motor 19 is fed with electric current by a control block 31 having the shape of a parallepiped box fixed inside the lintel. Control of the motor is made conventionally at low voltage (24 volts) or lower with variable speed control according to the varied voltage and intensity of the current. This box is fed by an electric low voltage (24 volts) transformer 33 itself fed from the current of the network and also fixed inside the lintel. A stand-by battery 35 is also fixed inside the lintel so as to feed the motor directly should the system break down in order to carry out emergency manœuvres for opening the doors of the booth and remove the trapped passengers.

Finally, the idle pulley 9 (FIG. 1) fixed to the opposite extremity of the lintel in relation to the motor pulley is identical in shape to that of the motor pulley 7 and is mounted on a stair head or housing 37 secured to the lintel.

Thus, the drive device with its pulleys, its door drive belt and its control and electric feed portion distributed inside the lintel and at the upper portion of the latter without projecting appears as a relatively complete and homogeneous compact unit and only requires a limited number of elements.

It shall be observed that the flat motor., by virtue of its light rotor and the associated speed reducer, has a relatively low movement of inertia and the movement is manually reversible by simply pushing the doors.

1. Support lintel for the doors of an elevator booth, comprising a device for driving said doors, that device being of the door (1) translation type with the aid of a drive belt (3) joined to the doors (1), including an electric motor (19) associated with a speed reducer (24) placed adjacent to the motor (19), and a drive pulley (7), said motor, reducer and pulley collectively fixed to said upper lintel (5), the motor (19) being powered by a control block (31), a transformer (33) and a stand-by battery, and wherein all elements of the door driving device, door drive belt and drive pulleys (7), motor (19) and speed reducer (24) and the control block and transformer, are fixed wholly within the lintel, to form a homogeneous block without projecting and are thereby protected within the lintel.

2. Support lintel according to claim 1, wherein said speed reducer (24) associated with the X motor (19) is one of the harmonic, cycloid or epicycloid type and fully housed inside the pulley (7).

3. Support lintel according to claim 1 wherein the electric motor (19) is a flat motor with a rotating armature disk (20) powered by low d.c. voltage by a contact brush collector (22) rubbing on the armature disk (20), said disk having a low inertia of rotation.

4. Support lintel according to claim 3, wherein the motor (19) and the speed reducer (24) joined to the drive pulley (7) are secured to the lintel (5) by a support plate (23) having said elements are placed on both sides thereof.

5. (cancelled)

6. Support lintel according to claim 1, wherein the control block (31) and transformer (33) are housed in the lintel (5) without projecting.

7. Support lintel according to claim 1, wherein the idle pulley (9) receiving the door drive belt (3) at the other end of the lintel (5) opposite to the motor (19) is mounted inside a housing (37) or frame secured to the lintel, the idle pulley (9) being identical to the drive pulley.

8. Support lintel according to claim 1, wherein the stand-by battery (35) is also installed in the internal section of the lintel (5) without projecting.

9. Support lintel according to claim 1, wherein the drive pulley (7) is adapted so as to cover at least a portion of the width of the reducer (24).
